(19) United States
(12) Patent Application Publication
(10) Pub. No.: US 2016/0054794 A1
(43) Pub. Date: Feb. 25, 2016

(54) EYE-CONTROL REMINDING METHOD, EYE-CONTROL IMAGE DISPLAY METHOD AND DISPLAY SYSTEM

(71) Applicant: BOE TECHNOLOGY GROUP CO., LTD., Beijing (CN)

(72) Inventor: Jing YU, Beijing (CN)

(73) Assignee: BOE TECHNOLOGY GROUP CO., LTD., Beijing (CN)

(21) Appl. No.: 14/518,160

(22) Filed: Oct. 20, 2014

(30) Foreign Application Priority Data
Aug. 22, 2014 (CN) 201410419777.1

(51) Int. Cl. G06F 3/01; G06K 9/00

(52) U.S. Cl. CPC G06F 3/013; G06K 9/00617

(57) ABSTRACT

An eye-control reminding method, an eye-control image display method and a display system are provided. The eye-control reminding method includes: detecting information related to an eye of a user in real time; comparing the information related to an eye of the user with a preset value; and determining eye-in-use status of the user according to the comparison result. When the comparison result is a set status, the user is reminded. Embodiments of the present invention may remind the user to protect eyes or focus attention, or can realize automatic adjustment of display contents and settings for viewing status of the user.

### TECHNICAL FIELD

At least one embodiment of the present invention relates to an eye-control reminding method, an eye-control image display method and a display system.

### BACKGROUND

With the development of science and technology, more and more digital products emerge in people's lives, such as mobile phones, digital televisions and flat computers.

Eye control technology is a novel control technology with its operating principle including: using a high-luminance reflection spot formed on the cornea of a user's eye by light emitted from a near infrared light source as a reference point, when an eyeball moves so as to stare at different locations on the screen, the light spot remains still while the pupil moves with respect to the light spot under the circumstances the eyeball approximates to a sphere. The line-of-sight direction is determined, the eyeball's track is recorded, etc. by means of the location relationship between the pupil center and the light spot. Eye control technology may be applied in digital products.

### SUMMARY

At least one embodiment of the present invention provides an eye-control reminding method, an eye-control image display method and a display system. One aspect of embodiments of the present invention may remind a user to protect eyes or focus attention; another aspect of embodiments of the present invention may achieve automatic adjustment of display contents and settings for the user's viewing status.

At least one embodiment of the present invention provides an eye-control reminding method including: detecting information related to an eye of a user in real time; comparing the information related to the eye of the user with a preset value; and determining eye-in-use status of the user according to a comparison result, for example reminding the user when the comparison result is a set status.

In various examples, the information related to an eye of a user may include at least one selected from the group consisting of tilt of eyes, detectability of eyes, blinking, distance between an eye and a set position, continuous viewing time and stare of an eye. In various examples, the set status may include at least one selected from the group consisting of A˜F: A. a duration for which a tilt angle of a line connecting two eyes of the user relative to a horizontal line is greater than a preset angle is longer than a first preset time; B. a duration of incapability of detecting eyes of the user is longer than a second preset time; C. a number of times of abnormal blinks of the user in a third preset time is greater than a preset number of times; D. a duration for which a distance between an eye of the user and a set position is smaller than a preset distance is greater than a fourth preset time; E. continuous viewing time of the user is greater than a fifth preset time; F. a duration for which an eye of the user stares in a set direction is greater than a sixth preset time.

At least one embodiment of the present invention provides an eye-control image display method including: detecting information related to an eye of a user in real time; comparing the information related to the eye of the user with a preset value; and controlling image display status according to a comparison result.

In various examples, the information related to an eye of a user may include at least one selected from the group consisting of tilt of eyes, detectability of eyes, blinking, distance between an eye and a screen, continuous viewing time and stare of an eye.

In various examples, the comparison result includes a set status and the set status may include at least one selected from the group consisting of A˜F: A. a duration for which a tilt angle of a line connecting two eyes of the user relative to a horizontal line is greater than a preset angle is longer than a first preset time; B. a duration of incapability of detecting eyes of the user is longer than a second preset time; C. a number of times of abnormal blinks of the user in a third preset time is greater than a preset number of times; D. a duration for which a distance between an eye of the user and a screen is smaller than a preset distance is greater than a fourth preset time; E. continuous viewing time of the user is greater than a fifth preset time; F. a duration for which an eye of the user stares in a set direction is greater than a sixth preset time.

In various examples, the controlling image display status may include at least one selected from the group consisting of pausing image display, displaying a prompt message, displaying a screen protection image, and normally displaying images.

In one example, the controlling image display status according to the comparison result may include: when the comparison result is the set status, pausing image display and/or displaying a prompt message.

In one example, the controlling image display status according to the comparison result may further include: when the comparison result is that a duration of the set status is greater than a seventh preset time, displaying a screen protection image; and when the comparison result is that the duration of the set status is less than or equal to the seventh preset time, resuming normal image display.

In one example, the controlling image display status according to the comparison result may further include: when the comparison result is that a duration for which the user's eye stare in a first preset direction is greater than an eighth preset time, displaying a Pause Display button; and/or when the comparison result is that a duration for which the user's eye stare in a second preset direction is greater than a ninth preset time, displaying an Exit button.

In one example, the controlling image display status according to the comparison result may further include: when the comparison result is that a duration for which the user's eye stare at the Pause Display button or the Exit button is greater than a tenth preset time, pausing image display or exiting image display; when the comparison result is that the duration for which the user's eye stare at the Pause Display button or the Exit button is less than or equal to the tenth preset time, normally displaying images.

At least one embodiment of the present invention further provides a display system including: an image display device for displaying images; a detecting device for detecting information related to an eye of a user in real time; a comparing device for acquiring the information related to the eye of the user from the detecting device and comparing the information related to the eye of the user with a preset value to determine whether it is a set status; and a control device for controlling image display status of the image display device when a comparison result of the comparing device is a set status.

In various examples, the detecting device detects at least one selected from the group consisting of tilt of eyes, detectability of eyes, blinking, distance between an eye and a screen, continuous viewing time and stare of an eye by using a user eye information acquiring device and a timing device.

In various examples, the comparing device determines the comparison result is a set status when the comparison result of the comparing device comprises at least one selected from the group consisting of A˜F: A. a duration for which a tilt angle of a line connecting two eyes of the user relative to a horizontal line is greater than a preset angle is longer than a first preset time; B. a duration of incapability of detecting eyes of the user is longer than a second preset time; C. a number of times of abnormal blinks of the user in a third preset time is greater than a preset number of times; D. a duration for which a distance between an eye of the user and a screen is smaller than a preset distance is greater than a fourth preset time; E. continuous viewing time of the user is greater than a fifth preset time; F. a duration for which an eye of the user stares in a set direction is greater than a sixth preset time.

In one example, the display system may further include a speaker for playing sounds. When the comparison result of the comparing device is the set status, the control device controls a speaking status of the speaker.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a flow chart showing an eye-control reminding method provided in one embodiment of the present invention;

FIG. 2 is a flow chart showing an eye-control image display method detecting eye-in-use status provided in one embodiment of the present invention;

FIG. 3 is a flow chart showing an eye-control operation of an eye-control image display method provided in one embodiment of the present invention;

FIG. 4 is a structure diagram showing a display system provided in one embodiment of the present invention.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

In making the present invention, the inventor found out that long-time and short-distance use of digital display equipments tends to cause eye problems such as eyestrain and vision diminution. Also, most of the current display equipments can not automatically adjust contents and settings of display according to viewing status of a user (for example, the distance between an eye of the user and the display equipment). Furthermore, in case of too frequent eye-control operations, eyestrain tends to occur for the user.

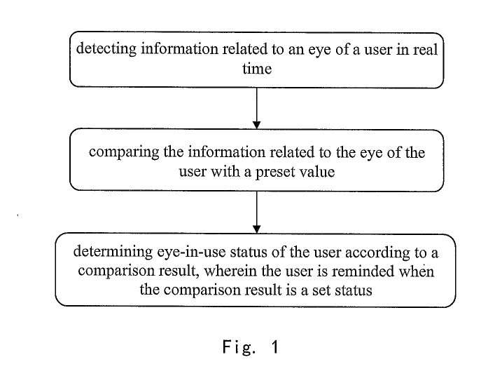

At least one embodiment of the present invention provides an eye-control reminding method. As shown in FIG. 1, the reminding method of the present embodiment includes: detecting information related to an eye of a user in real time; comparing the information related to the user's eye with a preset value; determining eye-in-use status of the user according to a comparison result; and reminding the user when the comparison result is a set status. For example, reminding the user by changing image display status and/or reminding user by sound. This reminding method may detect user's eye-in-use status in real time and remind the user to protect eyes or focus attention.

In various examples of embodiments of the present invention, it is possible to detect information of a user's eye (or information related to an eye in use) in real time by eye-control apparatus such as an eye tracker and a visual control instrument. For example, these eye-control apparatus such as eye trackers and visual control instruments may be commercial products and may include an image data acquisition part, a data analysis part, a data output part and so on. For example, eye-in-use information such as position coordinates of pupils of two eyes and stare time of the user is acquired by the eye tracker and these information is stored in the eye tracker's data analysis and recording device or system. For example, the pupil position coordinates may include two dimensional position coordinates and/or three dimensional position coordinates. In one example, the screen activity coordinate system is a two dimensional coordinate system, the user coordinate system is a three dimensional space coordinate system that may show the user's spatial position relative to the camera of the eye tracker and hence be applicable to detect, for example, the distance between eyes of the user and the screen. For example, the stare, time information includes a first entry time, a stare time at a first stare point and a duration of stare points. Note that, technologies well known by those skilled in the art may be used to acquire information such as position coordinates of eyes' pupils and stare time of a user with eye-control apparatus such as an eye tracker and a visual control instrument, which will not be described any more here.

In various examples, information related to a user's eye includes at least one selected from the group consisting of tilt of eyes, delectability of eyes (namely, whether it's possible to detect an eye), blinking, distance between an eye and a set position, continuous viewing time and stare of an eye. These information may be used to analyze the eye in use of the user. For example, it is possible to determine whether the eye-in-use status of the user is a set status, for example, a fatigue status, by detecting these information and comparing it with a preset value. For example, when it is determined that the eye-in-use status of the user is the fatigue status, it is possible to play a part in, for example, protecting eyes by reminding the user (for example, reminding the user to adapt his or her gesture).

In various examples, the set status include at least one selected from the group consisting of the following A˜F:

A. a duration for which a tilt angle of a line connecting two eyes of the user relative to the horizontal line is greater than a preset angle is longer than a first preset time;

B. a duration of incapability of detecting eyes of the user is longer than a second preset time;

C. a number of times of abnormal blinking of the user in a third preset time is greater than a preset number of times;

D. a duration for which a distance between an eye of the user and a set position is smaller than a preset distance is greater than a fourth preset time;

E. continuous viewing time of the user is greater than a fifth preset time;

F. a duration for which an eye of the user stares in a set direction is greater than a sixth preset time.

In one example, if the line connecting two eyes of the user tilts more than 15 degrees relative to the horizontal line for more than 3 seconds, it is determined that the two eyes are tilt.

In one example, if it's impossible to detect both eyes of the user (namely neither the left eye nor the right eye of the user is detected) for more than 5 s, it is determined that two eyes are not detected.

In one example, if the distance between the user's two eyes and a set position (for example, the screen of a display device) is smaller than 50 centimeters (cm) for more than 3 s, it is determined that the distance between the user's eyes and the set position is too small.

In embodiments of the present invention, the duration for which an eye opens from being closed is one blink. In one example, when the eye's pupil can not be detected (corresponding to closure of eye), timing is started and stopped till the next detection of the pupil (corresponding to eye opening). The time difference is determined, and if it's smaller than 3 s, a normal blink is asserted, and if it's greater than 3 s, an abnormal blink is asserted. It is determined whether abnormal blinks during a certain time period (for example 90 s) are greater than 3, and if so, it is determined that the frequency of blink is too low.

In one example, if an eye is detected, it is considered that the user is viewing, and when the duration of continuous viewing is greater than 180 minutes (min), it is determined as a too long viewing time.

In summary, in various examples, the set status may be at least one selected from the group consisting of tilt eyes, incapability of detecting eyes, too small distance between an eye and a set position, too low blink frequency and too long viewing time. Note that, preset values of the above-mentioned indicators may be set according to practical demands rather than being limited to the above-mentioned examples. For example, for the distance between the user's eyes and a set position (e.g. the screen of a display device), when the display device is a TV set, the distance between the user's eyes and the screen may be set to 3 m, and when the display device is a learning machine, the distance between the user's eyes and the screen may be set to 30 cm. For example, for the blink frequency, when the user is talking to a person, the frequency is 15/min, for example; and when the user is reading, the frequency is 6/min, for example. Accordingly, time intervals between two blinks are about 4 s and 10 s respectively. Thereby, the abnormal blink time may also be adjusted accordingly. Furthermore, the above-mentioned examples are described in terms of reminding the user to protect eyes, the uses of the eye-control reminding method in embodiments of the present invention are not limited thereto. For example, it is possible to remind the user to focus attention by detecting the duration for which eyes of the user stare in a set direction to thereby improve the efficiency of the user's reading or learning.

In various examples, the changing image display status may be at least one selected from the group consisting of pausing image display, displaying a prompt message, and displaying a screen protection image. For example, when the eye-in-use status of the user is detected to be at least one selected from the group consisting of tilt eyes, incapability of detecting eyes, too small distance between an eye and a screen, too low blink frequency, too long viewing time and too long time stare in a set direction, the image display status may be changed to pausing image display and/or displaying a prompt message. Thereafter, if in a set period, the user fails to adjust eye-in-use status, it is possible to display a screen protection image or shutdown temporarily. If in a set period, the user adjusts his or her eye-in-use status to meet requirements, normal image display is resumed. However, embodiments of the present invention are not limited thereto.

In at least one example, the user may be reminded by sounds, for example, which may be implemented by playing set sounds with a speaker. A cue light (for example, a light emitting diode) or the like may also be used to remind users.

At least one embodiment of the present invention further provides an eye-control image display method. The method includes: detecting information related to an eye of a user; comparing the information related to the eye of the user with a preset value; and controlling image display status according to a comparison results. One aspect of the display method according to embodiments of the present invention may detect user's eye-in-use status in real time and remind the user to protect eyes or focus attention. Another aspect of the display method according to embodiments of the present invention may realize automatic adjustment of display contents and settings for user's viewing status.

In various examples, information related to an eye of the user may be detected in real time with apparatus such as an eye tracker and a visual control instrument. For example, information such as position coordinates of pupils of two eyes and stare time is acquired by the eye tracker and these information is stored in the eye tracker's data analysis and recording device or system. Description of the eye-control equipments may be found in the above contents.

In various examples, information related to a user's eye includes at least one selected from the group consisting of tilt of eyes, detectability of eyes, blinking, distance between an eye and a set position, continuous viewing time and stare of an eye. These indicators may be used to analyze viewing of the user. For example, it is possible to determine whether the user's viewing is a set status according to a comparison result by detecting these indicators and comparing them with a preset value. If it is the set status, display contents or settings corresponding to the set status are implemented, or the user is reminded to protect eyes or focus attention.

In various examples, the comparison result includes set status and the set status may include at least one selected from the group consisting of the following A˜F:

A. a duration for which a tilt angle of a line connecting two eyes of the user relative to the horizontal line is greater than a preset angle is longer than a first preset time;

B. a duration of incapability of detecting eyes of the user is longer than a second preset time;

C. a number of times of abnormal blinks of the user in a third preset time is greater than a preset number of times;

D. a duration for which a distance between an eye of the user and a screen is smaller than a preset distance is greater than a fourth preset time;

E. continuous viewing time of the user is greater than a fifth preset time;

F. a duration for which an eye of the user stares in a set direction is greater than a sixth preset time.

The above-described embodiments may be referred to, for value settings of parameters in the above-mentioned A˜F, which will not be described any more here.

In various examples, the controlling image display status may include at least one selected from the group consisting of pausing image display, displaying a prompt message, displaying a screen protection image, and normally displaying images. However, embodiments of the present invention are not limited thereto. Furthermore, for example, these modes of controlling image display status may further be combined in proper order.

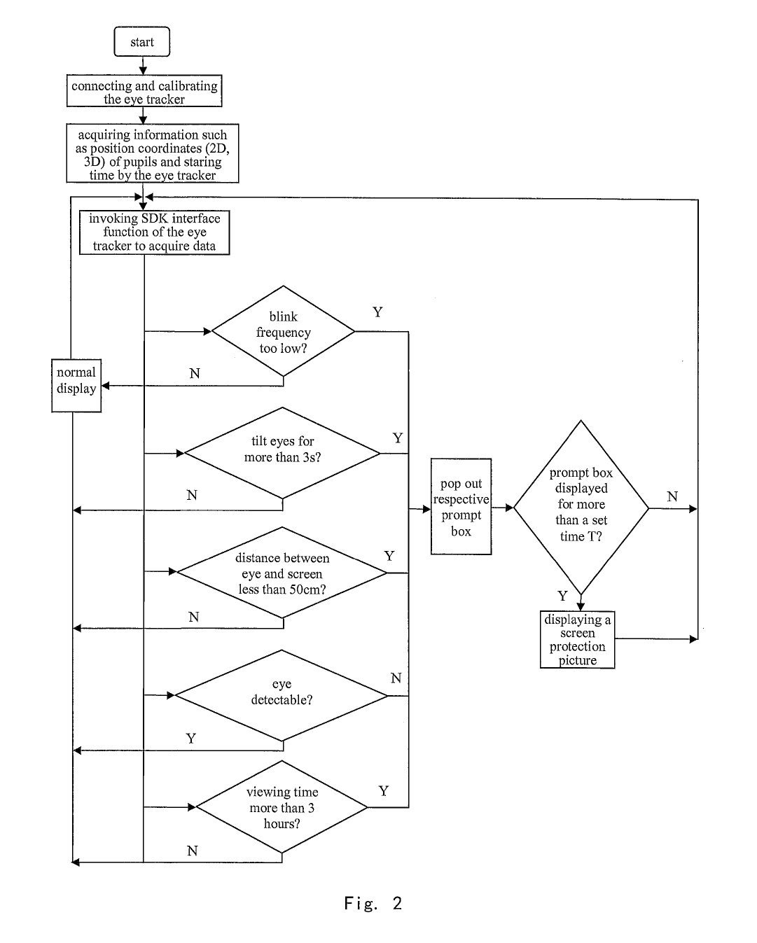

For example, in one example, the controlling image display status according to the comparison result may include: when the comparison result is the set status, pausing image display and/or displaying a prompt message. On the basis of the above-mentioned examples, in another example, when the comparison result is that the duration of the set status is greater than a seventh preset time, a screen protection image is displayed; and when the comparison result is that the duration of the set status is less than or equal to the seventh preset time, normal image display is resumed. For example, assuming that the set status is a fatigue eye-in-use status, the seventh preset time is T, it is concluded that the user is in the fatigue eye-in-use status according to the comparison result at instant t1, and it is concluded that the user is no longer in the fatigue eye-in-use status at instant t2. If t2−t1≦T, that is, the duration of the set status is less than or equal to the seventh preset time, which means the user has made effective feedback in the seventh preset time T, then after instant t2, the image display status is resumed as normal image display from the above-mentioned pausing image display and/or displaying a prompt message. If in the seventh preset time, the user fails to make effective feedback, then after instant t1+T (now t2−t1>T, that is, the duration of the set status is greater than the seventh preset time), the image display status is control to become displaying a screen protection image from the above-mentioned pausing image displaying and/or displaying a prompt message, or even shutting down temporarily, as shown in FIG. 2.

In one example, the controlling image display status according to the comparison result may further include: when the comparison result is that the duration for which an eye of the user stare in a first preset direction is greater than an eighth preset time, displaying a Pause Display button; and/or when the comparison result is that the duration for which an eye of the user stare in a second preset direction is greater than a ninth preset time, displaying an Exit button.

In one example, the controlling image display status according to the comparison result may further include: when the comparison result is that the duration for which an eye of the user stare at the Pause Display button or the Exit button is greater than a tenth preset time, pausing image display or exiting image display; when the comparison result is that the duration for which an eye of the user stare at the Pause Display button or the Exit button is less than or equal to the tenth preset time, resuming normal image display. Eye-control operations such as pausing, normal displaying, and exiting of image display are realized by staring in a set direction, which may further optimize eye-control operations.

The operation process of realizing automatic adjustment of display contents and settings in embodiments of the present invention will be described below with respect to an example of determining whether the user's view status is the fatigue eye-in-use status. FIG. 2 is a flow chart showing an eye-control image display method provided in one embodiment of the present invention. In this embodiment, information such as position coordinates of two eyes' pupils and stare time is acquired with an eye tracker, a visual control instrument or the like and viewing of the user is detected in real time when the user is viewing. Description of the eye-control equipments may be found in the above contents.

When comparing the detected information related to the user's eye with a preset value, indicators from blinks, tilt of eyes, distance between an eye and a screen, eye detectability to continuous viewing time are compared in turn with their corresponding preset values. Of course, the above-mentioned indicators may also be compared in parallel. In one example, When it is determined there is any case as shown in FIG. 2 (namely fatigue eye-in-use status) according to the comparison result, detection of other indicators is stopped, respective prompt message is displayed (for example, displaying a prompt box), and timing is started (for example, timing may be performed by a timer). For example, the process of displaying a prompt message of tilt eyes may be that: the prompt box reminds the user of tilt eyes and displays counting down, if within the time period (namely the seventh preset time), the user adjusts the viewing mode to meet requirements, then the prompt box disappears, images are normally displayed, the timer is cleared, and all status detections are turned on; if within the time period, the user makes no respective feedback, then after the counting down is completed, a screen protection picture is displayed in full screen, and the timer is reset at the same time until the user adjusts viewing mode to meet requirements, then images are normally displayed and all status detections are turned on. Note that, the time displayed in the prompt box in FIG. 2 shows the duration of a set status. The display of images may or may not be paused while the prompt message is displayed. Furthermore, after the screen protection picture is displayed, it is also possible to pause image display, and wait for the user to handle manually.

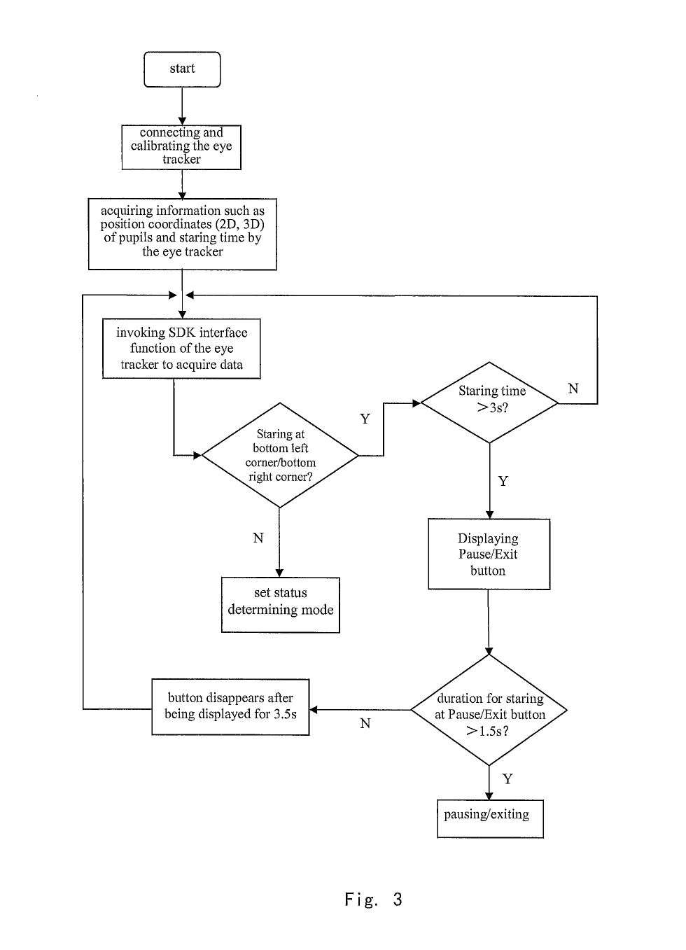

As shown in FIG. 3, the eye-control image display method provided in embodiments of the present invention can provide simple eye-control operations. For example, during normal viewing of the user, if the user stares at the lower-left corner for more than 3 s (an example of the eighth preset time), a Pause button is displayed and timing is started (for example, the timing can be performed by a timer). If the user stares at the Pause button for more than 1.5 s (an example of the tenth preset time), the play is paused and the timer is cleared; else the Pause button is displayed for 3.5 s and then disappears, images are normally displayed, and the timer is cleared. Similarly, if the user stares at the lower-right corner for more than 3 s (an example of the ninth preset time), an Exit button is displayed and the timer starts timing. If the user stares at the Exit button for more than 1.5 s (an example of the tenth preset time), image display is exited and the timer is cleared. Otherwise, the Exit button disappears after being displayed for 3.5 s, images are normally displayed, and the timer is cleared. If the user neither stares at the bottom left corner nor stares at the bottom right corner, a set status judgment mode as shown in FIG. 2 is entered. Eye-control operations such as pausing, normal displaying, and exiting of image display are realized by staring in a set direction, which may further optimize eye-control operations.

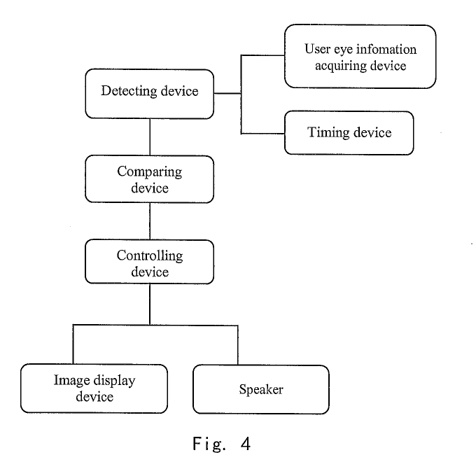

At least one embodiment of the present invention further provides a display system. As shown in FIG. 4, the display system includes: an image display device for displaying images; a detecting device for detecting information related to a user's eye in real time; a comparing device for acquiring information related to the user's eye from the detecting device and comparing the information with a preset value to determine whether it is a set status; and a control device for controlling image display status of the image display device when the comparison result of the comparing device is the set status.

One aspect of the display system according to embodiments of the present invention may detect user's viewing status in real time and remind the user to protect eyes or focus attention. Another aspect of the display system according to embodiments of the present invention may realize automatic adjustment of display contents and settings for user's viewing status.

In various examples, the image display device may be any device with display function, such as a liquid crystal display panel, an organic light emitting diode display panel, an electronic paper display panel, etc. The detecting device may be an eye-control apparatus such as an eye tracker or a visual control instrument. The comparing device may be a device with comparing and determining functions that may be implemented by a general purpose computer or a dedicated computer, for example. The controlling device may also be implemented by a general purpose computer or a dedicated computer, such as a central processing unit (CPU), a programmable logic controller (PLC), etc. These parts may be combined in any manner or provided independently. For example, the detecting device may be combined with the image display device and disposed on a side facing the user, or provided independently of the image display device.

In one example, the detecting device may include a user eye information acquiring device and a timing device for detecting information related to an eye of the user comprising at least one selected from the group consisting of tilt of eyes, detectability of eyes, blinking, distance between an eye and a screen, continuous viewing time, stare of an eye and the like. These indicators may be used to analyze viewing of the user. For example, it is possible to detect these indicators by the detecting device and compare them with preset values by the comparing device, and determine whether the user's viewing status is a set status according to the comparison result. If it's a set status, the control device controls the image display device to execute display contents or settings corresponding to the set status, which will not be described any more here. In various examples, the set status may be at least one selected from the group consisting of the following A˜F:

A. a duration for which a tilt angle of a line connecting two eyes of the user relative to a horizontal line is greater than a preset angle is longer than a first preset time;

B. a duration of incapability of detecting eyes of the user is longer than a second preset time;

C. a number of times of abnormal blinks of the user in a third preset time is greater than a preset number of times;

D. a duration for which a distance between an eye of the user and a screen is smaller than a preset distance is greater than a fourth preset time;

E. continuous viewing time of the user is greater than a fifth preset time;

F. a duration for which an eye of the user stares in a set direction is greater than a sixth preset time.

The above-described embodiments may be referred to, for value settings of parameters in the above-mentioned A˜F, which will not be described any more here.

In one example, the comparing device may acquire data of information related to a user's eye by invoking SDK interface function of the eye tracker, as shown in FIG. 2.

In one example, the display system may further include a speaker for playing sounds. In one example, when the comparison result of the comparing device is the set status, the control device controls the speaking status of the speaker. For example, when the comparison result of the comparing device indicates that the user is in a fatigue eye-in-use status, the control device may control the speaker to play a set sound, and thus to remind the user to protect eyes. Of course, it is also possible to control the image display status of the image display device to remind the user to protect eyes.

In summary, in the above-mentioned embodiments of the present invention, by detecting information related to a user's eye in real time, it is possible on the one hand to remind the user to protect eyes or focus attention, and on the other hand to automatically adjust display contents and settings when it is determined after comparison that the user's viewing status is a set status by setting display contents and setting corresponding to the set status.

What are described above is related to the illustrative embodiments of the disclosure only and not limitative to the scope of the disclosure; the scopes of the disclosure are defined by the accompanying claims.

1. An eye-control reminding method, comprising:
detecting information related to an eye of a user in real time;
comparing the information related to the eye of the user with a preset value; and
determining eye-in-use status of the user according to a comparison result, wherein the user is reminded when the comparison result is a set status.

2. The eye-control reminding method of claim 1, wherein the information related to an eye of a user comprises at least one selected from the group consisting of tilt of eyes, detectability of eyes, blinking, distance between an eye and a set position, continuous viewing time and stare of an eye.

3. The eye-control reminding method of claim 1, wherein the set status comprises at least one selected from the group consisting of A˜F, wherein,
A. a duration for which a tilt angle of a line connecting two eyes of the user relative to a horizontal line is greater than a preset angle is longer than a first preset time;
B. a duration of incapability of detecting eyes of the user is longer than a second preset time;
C. a number of times of abnormal blinks of the user in a third preset time is greater than a preset number of times;
D. a duration for which a distance between an eye of the user and a set position is smaller than a preset distance is greater than a fourth preset time;
E. continuous viewing time of the user is greater than a fifth preset time; and
F. a duration for which an eye of the user stares in a set direction is greater than a sixth preset time.

4. The eye-control reminding method of claim 2, wherein the set status comprises at least one selected from the group consisting of A˜F, wherein,
A. a duration for which a tilt angle of a line connecting two eyes of the user relative to a horizontal line is greater than a preset angle is longer than a first preset time;
B. a duration of incapability of detecting eyes of the user is longer than a second preset time;
C. a number of times of abnormal blinks of the user in a third preset time is greater than a preset number of times;
D. a duration for which a distance between an eye of the user and a set position is smaller than a preset distance is greater than a fourth preset time;
E. continuous viewing time of the user is greater than a fifth preset time; and
F. a duration for which an eye of the user stares in a set direction is greater than a sixth preset time.

5. An eye-control image display method, comprising:
detecting information related to an eye of a user in real time;
comparing the information related to the eye of the user with a preset value; and
controlling image display status according to a comparison result.

6. The eye-control image display method of claim 5, wherein the information related to an eye of a user comprises at least one selected from the group consisting of tilt of eyes, detectability of eyes, blinking, distance between an eye and a screen, continuous viewing time and stare of an eye.

7. The eye-control image display method of claim 5, wherein the comparison result comprises a set status comprising at least one selected from the group consisting of A˜F, wherein,
A. a duration for which a tilt angle of a line connecting two eyes of the user relative to a horizontal line is greater than a preset angle is longer than a first preset time;
B. a duration of incapability of detecting eyes of the user is longer than a second preset time;
C. a number of times of abnormal blinks of the user in a third preset time is greater than a preset number of times;
D. a duration for which a distance between an eye of the user and a screen is smaller than a preset distance is greater than a fourth preset time;
E. continuous viewing time of the user is greater than a fifth preset time; and
F. a duration for which an eye of the user stares in a set direction is greater than a sixth preset time.

8. The eye-control image display method of claim 6, wherein the comparison result comprises a set status comprising at least one selected from the group consisting of A˜F, wherein,
A. a duration for which a tilt angle of a line connecting two eyes of the user relative to a horizontal line is greater than a preset angle is longer than a first preset time;
B. a duration of incapability of detecting eyes of the user is longer than a second preset time;
C. a number of times of abnormal blinks of the user in a third preset time is greater than a preset number of times;
D. a duration for which a distance between an eye of the user and a screen is smaller than a preset distance is greater than a fourth preset time;
E. continuous viewing time of the user is greater than a fifth preset time; and
F. a duration for which an eye of the user stares in a set direction is greater than a sixth preset time.

9. The eye-control image display method of claim 5, wherein the controlling image display status comprises at least one selected from the group consisting of pausing image display, displaying a prompt message, displaying a screen protection image and normally displaying images.

10. The eye-control image display method of claim 6, wherein the controlling image display status comprises at least one selected from the group consisting of pausing image display, displaying a prompt message, displaying a screen protection image and normally displaying images.

11. The eye-control image display method of claim 7, wherein the controlling image display status according to the comparison result comprises:
when the comparison result is the set status, pausing image display and/or displaying a prompt message.

12. The eye-control image display method of claim 8, wherein the controlling image display status according to the comparison result comprises:
when the comparison result is the set status, pausing image display and/or displaying a prompt message.

13. The eye-control image display method of claim 11, wherein the controlling image display status according to the comparison result further comprises:
when the comparison result is that a duration of the set status is greater than a seventh preset time, displaying a screen protection image; and
when the comparison result is that the duration of the set status is less than or equal to the seventh preset time, resuming normal image display.

14. The eye-control image display method of claim 5, wherein the controlling image display status according to the comparison result further comprises:
when the comparison result is that a duration for which the user's eye stare in a first preset direction is greater than an eighth preset time, displaying a Pause Display button; and/or
when the comparison result is that a duration for which the user's eye stare in a second preset direction is greater than a ninth preset time, displaying an Exit button.

15. The eye-control image display method of claim 14, wherein the controlling image display status according to the comparison result further comprises:
when the comparison result is that a duration for which the user's eye stare at the Pause Display button or the Exit button is greater than a tenth preset time, pausing image display or exiting image display;
when the comparison result is that a duration for which the user's eye stare at the Pause Display button or the Exit button is less than or equal to the tenth preset time, normally displaying images.

16. A display system, comprising:
an image display device for displaying images;
a detecting device for detecting information related to an eye of a user in real time;
a comparing device for acquiring the information related to the eye of the user from the detecting device and comparing the information related to the eye of the user with a preset value to determine whether it is a set status; and
a control device for controlling image display status of the image display device when a comparison result of the comparing device is a set status.

17. The display system of claim 16, wherein the detecting device detects at least one selected from the group consisting of tilt of eyes, detectability of eyes, blinking, distance between an eye and a screen, continuous viewing time and stare of an eye by using a user eye information acquiring device and a timing device.

18. The display system of claim 16, wherein the comparing device determines the comparison result is the set status when the comparison result of the comparing device comprise at least one selected from the group consisting of A˜F, wherein
A. a duration for which a tilt angle of a line connecting two eyes of the user relative to a horizontal line is greater than a preset angle is longer than a first preset time;
B. a duration of incapability of detecting eyes of the user is longer than a second preset time;
C. a number of times of abnormal blinks of the user in a third preset time is greater than a preset number of times;
D. a duration for which a distance between an eye of the user and a screen is smaller than a preset distance is greater than a fourth preset time;
E. continuous viewing time of the user is greater than a fifth preset time; and
F. a duration for which an eye of the user stares in a set direction is greater than a sixth preset time.

19. The display system of claim 17, wherein the comparing device determines the comparison result is the set status when the comparison result of the comparing device comprise at least one selected from the group consisting of A˜F, wherein
A. a duration for which a tilt angle of a line connecting two eyes of the user relative to a horizontal line is greater than a preset angle is longer than a first preset time;
B. a duration of incapability of detecting eyes of the user is longer than a second preset time;
C. a number of times of abnormal blinks of the user in a third preset time is greater than a preset number of times;
D. a duration for which a distance between an eye of the user and a screen is smaller than a preset distance is greater than a fourth preset time;
E. continuous viewing time of the user is greater than a fifth preset time; and
F. a duration for which an eye of the user stares in a set direction is greater than a sixth preset time.

20. The display system of claim 16, further comprising a speaker for playing sounds, wherein when the comparison result of the comparing device is the set status, the control device controls a speaking status of the speaker.
